(19) United States
(12) Patent Application Publication
(10) Pub. No.: US 2022/0198394 A1
(43) Pub. Date: Jun. 23, 2022

(54) SECURED DATA WORKFLOW INTEGRATION AND METHODS THEREOF

(71) Applicant: Capital One Services, LLC, McLean, VA (US)

(72) Inventor: Niharendu Chandra, McLean, VA (US)

(21) Appl. No.: 17/132,601

(22) Filed: Dec. 23, 2020

(51) Int. Cl. G06Q 10/10; G06Q 20/20; H04L 29/06

(52) U.S. Cl. CPC G06Q 10/103; G06Q 20/206; H04L 2463/082; H04L 63/0807; H04L 63/12; G06Q 20/202

(57) ABSTRACT

The present disclosure includes systems and methods enabling secure workflows by using a processor to receive an activity verification request from an initiator device associated with an entity in response to a user interaction by a user, where the activity verification request includes an identifier in an auxiliary data field of a messaging standard. Using the identifier from the auxiliary data field, the processor determines a secure workflow and generates a workflow token for validation with a workflow service. The processor transmits the workflow token to the initiator device and receives from the initiator device a workflow request including the workflow token. The processor executes, within the workflow service, an instance of the secure workflow according to the workflow request and confidential user data of the user inaccessible to the entity. The processor generates a notification according to the execution of the instance of the secure workflow.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in drawings that form a part of this document: Copyright, Capital One Services, LLC, All Rights Reserved.

### FIELD OF TECHNOLOGY

The present disclosure generally relates to computer-based systems configured for secured data workflow integration and methods thereof, including entity-agnostic user communication services with improved user data security.

### BACKGROUND OF TECHNOLOGY

Electronic accounts can sometimes be used by a user to engage in an electronic activity with a third-party. Often, the third-party may need user data to effectuate processes related to the electronic activity, such as sending a communication to the user regarding the electronic activity. Typically, the user would then provide personal contact information or other sensitive user data to the third-party, so the processes may be performed. However, the user sharing contact information with the third-party erodes the user's control of personal information and sensitive data, not to mention requires cumbersome and repetitive processes to provide the data to the third-party. Indeed, each entity that has access to the user's data is another opportunity for that data to be comprised or mishandled. Accordingly, a solution for secure and efficient direct contact to a user is needed.

### SUMMARY OF DESCRIBED SUBJECT MATTER

In some embodiments, the present disclosure provides an exemplary technically improved computer-based method that includes at least the following steps of receiving, by at least one processor, an activity verification request from an initiator device associated with an entity in response to a user interaction of a user with the initiator device; where the activity verification request includes a plurality of data fields associated with a messaging standard; where the plurality of data fields include at least one auxiliary data field; where the at least one auxiliary data field includes an identifier of a workflow associated with the entity; determining, by the at least one processor, a secure workflow based at least in part on: i) the identifier of the workflow, and ii) at least one registered workflow; generating, by the at least one processor, a device-specific workflow token for a workflow service to execute a device-specific instance of the secure workflow; where the device-specific workflow token is associated with the initiator device; transmitting, by the at least one processor, the device-specific workflow token to the initiator device; receiving, by the at least one processor from the initiator device, a workflow request including workflow data and the device-specific workflow token; where the workflow data includes: i) at least one trigger condition, and ii) an indication of the at least one trigger condition having been satisfied; executing, by the at least one processor, within the workflow service, the device-specific instance of the secure workflow based at least in part on: i) the workflow request, and ii) user data of the user; where the user data of the user confidentially stored separate from the entity; generating, by the at least one processor, at least one status notification in response to the executing of the device-specific instance of the secure workflow; where the at least one status notification includes the indication of the at least one trigger condition having been satisfied; and transmitting, by the at least one processor, the at least one status notification to the initiator device, a computing device associated with the user, or both.

In some embodiments, the present disclosure provides another exemplary technically improved computer-based system that includes at least the following components of at least one processor configured to execute software instruction. The software instruction cause the at least one processor to perform steps to: receive an activity verification request from an initiator device associated with an entity in response to a user interaction of a user with the initiator device; where the activity verification request includes a plurality of data fields associated with a messaging standard; where the plurality of data fields include at least one auxiliary data field; where the at least one auxiliary data field includes an identifier of a workflow request associated with the entity; determine a secure workflow based at least in part on: i) the identifier of the workflow request, and ii) at least one registered workflow; generate a device-specific workflow token for a workflow service to execute a device-specific instance of the secure workflow; where the device-specific workflow token is associated with the initiator device; transmit the device-specific workflow token to the initiator device; receive, from the initiator device, a workflow request including workflow data and the device-specific workflow token; where the workflow data includes: i) at least one trigger condition, and ii) an indication of the at least one trigger condition having been satisfied; execute within the workflow service, the device-specific instance of the secure workflow based at least in part on: i) the workflow request, and ii) user data of the user; where the user data of the user confidentially stored separate from the entity; generate at least one status notification in response to the executing of the device-specific instance of the secure workflow; where the at least one status notification includes the indication of the at least one trigger condition having been satisfied; and transmit the at least one status notification to the initiator device, a computing device associated with the user, or both.

In some embodiments, the present disclosure provides another exemplary technically improved computer-based method that includes at least the following steps of receiving, by at least one processor, an authorization request from an initiator device associated with an entity in response to a user interaction of a user with the initiator device; where the authorization request includes a plurality of data fields associated with a messaging standard; where the plurality of data fields include at least one auxiliary data field; where the at least one auxiliary data field includes an identifier of a workflow associated with the entity; determining, by the at least one processor, a secure workflow based at least in part on: i) the identifier of the workflow, and ii) at least one registered workflow; executing, by the at least one processor, within a workflow service, an instance of the secure workflow to produce at least one device-specific activity-related notification based at least in part on: i) the authorization request, and ii) user data of the user; where the user data of the user confidentially stored separate from the entity; and transmitting, by the at least one processor, the at least one device-specific activity-related notification a computing device associated with the user.

In some embodiments, the present disclosure provides exemplary technically improved computer-based systems and methods as set forth above, further including electronically communicating, by the at least one processor, the at least one status notification to contact information identified in the user data, where the contact information identifies a communication address of the computing device.

In some embodiments, the present disclosure provides exemplary technically improved computer-based systems and methods as set forth above, where the contact information includes a telephone number specified in a user account at a financial institution and the at least one status notification includes a text message to the telephone number.

In some embodiments, the present disclosure provides exemplary technically improved computer-based systems and methods as set forth above, where the device-specific workflow token is a one-time token that expires upon generating the at least one status notification.

In some embodiments, the present disclosure provides exemplary technically improved computer-based systems and methods as set forth above, where the messaging standard includes an authorization message standard.

In some embodiments, the present disclosure provides exemplary technically improved computer-based systems and methods as set forth above, where the at least one auxiliary data field includes at least one data field of the messaging standard that is reserved for private use.

In some embodiments, the present disclosure provides exemplary technically improved computer-based systems and methods as set forth above, where the initiator device includes a payment system associated with a merchant.

In some embodiments, the present disclosure provides exemplary technically improved computer-based systems and methods as set forth above, further including receiving, by the at least one processor, the workflow request including a transaction fulfillment message from a merchant associated with the initiator device, where the transaction fulfillment message indicates a fulfillment of a status of a transaction associated with the activity verification request.

In some embodiments, the present disclosure provides exemplary technically improved computer-based systems and methods as set forth above, further including: generating, by the at least one processor, a multi-factor authentication token based on the secure workflow; and electronically communicating, by the at least one processor, the multi-factor authentication token to the initiator device, the at least one computing device, or both to authenticate the user with the initiator device.

In some embodiments, the present disclosure provides exemplary technically improved computer-based systems and methods as set forth above, where the at least one status notification includes a purchased item shipping status.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIGS. 1-7 show one or more schematic flow diagrams, certain computer-based architectures, and/or screenshots of various specialized graphical user interfaces which are illustrative of some exemplary aspects of at least some embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

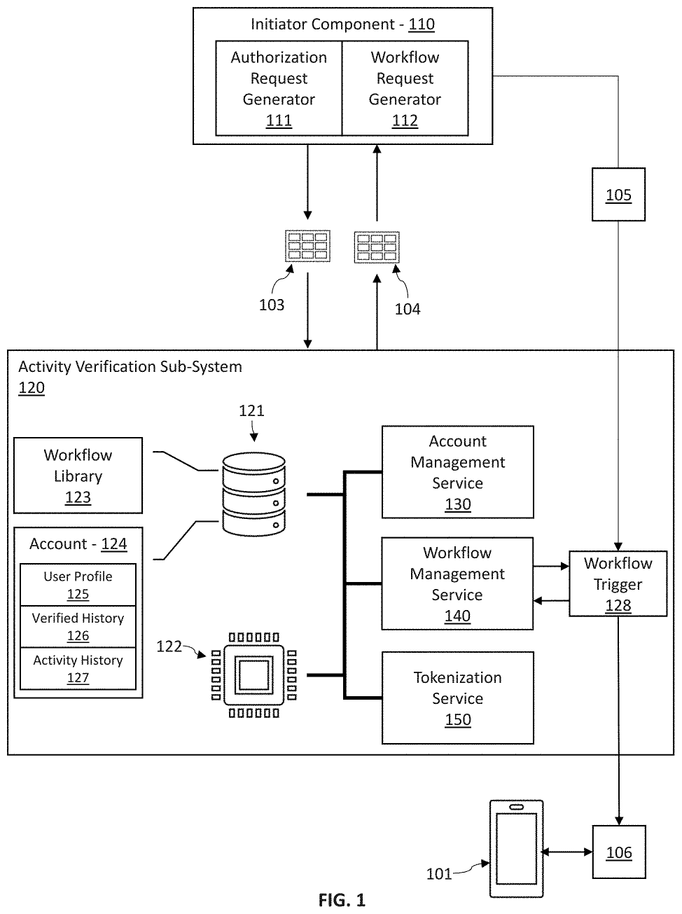

FIGS. 1 through 7 illustrate systems and methods of computer-based interaction (e.g., communication) with one or more users. The following embodiments provide technical solutions and technical improvements that overcome technical problems, drawbacks and/or deficiencies in the technical fields involving efficiency of electronic interaction, including, without limitation, computer-based communication and user data privacy and/or security. As explained in more detail, below, technical solutions and technical improvements herein include aspects of improved user authentication and/or activity authentication requests to enable computer-based interaction (e.g., direct contact) with the user without accessing user contact data.

There may be scenarios where a user may utilize an electronic account to engage in an electronic activity with a third-party. Often, the third-party may need to send the user a communication regarding the electronic activity. However, the user sharing contact information with the third-party erodes the user's control of personal information and/or sensitive data. Each entity that has access to the user's data is another opportunity for that data to be comprised or mishandled. Accordingly, improvements that enable user-interaction (e.g., direct contact) by the third-party entity with the user without relying on user's contact information, thus improving the security and/or confidentiality of the user's data.

For example, password services are employed for one-click logins at websites and internet-based services. Such one-click logins enable a user to login to their account with the password service and leverage a plug-in with individual websites and services authenticate access via the password service, rather than creating or logging in to an account specific to each individual website and service. Embodiments of the present disclosure can leverage the relationship of the password service with each individual website and service to provide additional workflows, such as notifications to the user or other functionalities requiring user data, without allowing the individual websites and services access to the user data required for the workflow.

As another example, multi-factor authentication for user accounts may further improve security of the user accounts. In some embodiments, an illustrative computer system of the present disclosure may be configured to leverage the relationship with a password service, financial entity (e.g., account) and/or other trusted entity (e.g., account) to provide additional workflows to generate and/or communicate multi-factor authentication tokens to the user, without a need for third-party systems to access to the user contact information.

As another example, in user service contexts where a user pays a service provider or merchant using a financial account (e.g., using a credit card, debit card, contactless payment, or other suitable payment technology), the user often have to wait for fulfillment of her/his order. For example, to mitigate this illustrative problem, service providers and merchants may use a variety of computer-based tools such as queue management system, notification devices etc. However, at least some of tools may require user to carry around a device and/or keep looking for their order number on a screen, and/or to provide personal contact information. For example, some embodiments of the illustrative system leverage the financial institution holding the financial account of the user to enable an electronic payment-based order fulfillment system that allows any user paying via an electronic payment method to receive notifications on their mobile devices without having to register themselves with the business. In particular, in some embodiments, contact with the user can be effectuated using a workflow that does not require the user to provide contact information to the service provider or merchant, such as through a service (“Agnostic Notification”) owned by the bank on fulfillment of an electronic payment request and the associated service. Because the financial intuition has an existing relationship with the user, and has user contact information, the financial institution may utilize specially customized transaction request messages to trigger the workflow providing the notification service. Thus, the user data is protected from third-parties while enabling direct contact between the service provider or merchant and the user.

Based on such technical features, further technical benefits become available to users and operators of these systems and methods. Moreover, various practical applications of the disclosed technology are also described, which provide further practical benefits to users and operators that are also new and useful improvements in the art.

FIGS. 1 through 7 illustrate systems and methods of direct communication to one or more users. The following embodiments provide technical solutions and technical improvements that overcome technical problems, drawbacks and/or deficiencies in the technical fields involving efficiency of electronic communication and user data privacy and security. As explained in more detail, below, technical solutions and technical improvements herein include aspects of improved user authentication or activity authentication requests to enable direct contact with the user without accessing user contact data.

There may be scenarios where a user may utilize an electronic account to engage in an electronic activity with a third-party. Often, the third-party may need to send the user a communication regarding the electronic activity. The user sharing contact information with the third-party erodes the user's control of personal information and sensitive data. Each entity that has access to the user's data is another opportunity for that data to be comprised or mishandled. Accordingly, improvements that enable direct contact by the third-party entity to the user without providing contact information with the third-party entity can improve the security and confidentiality of the user's data.

For example, password services are employed for one-click logins at enrolled websites and interne-based services. Such one-click logins enable a user to login to their account with the password service and leverage a plug-in with individual websites and services authenticate access via the password service, rather than creating or logging in to an account specific to each individual website and service. Embodiments of the present disclosure can leverage the relationship of the password service with each individual website and service to provide additional workflows, such as notifications to the user or other functionalities requiring user data, without allowing the individual websites and services access to the user data required for the workflow.

As another example, in user service contexts where a user pays a service provider or merchant with using a financial account (e.g., using a credit card, debit card, contactless payment, or other suitable payment technology), the users often must wait for fulfillment of their orders. This limits the freedom of users to move around and participate in other activities. In order to mitigate this problem service providers and merchants use a variety of tools such as queue management system, notification devices etc. However, these tools are cumbersome and require users to carry around a device or keep looking for their order number on a screen, or to provide personal contact information.

For example, some embodiments of the present disclosure may leverage a computer-interaction with the financial institution that is associated with the financial account of the user to enable an electronic payment-based order fulfillment system that allows any user paying via an electronic payment method to receive notifications on their mobile devices in real-time without having to register themselves with the business. In some embodiments, contact with the user can be effectuated using a workflow that does not require the user to provide contact information to the service provider or merchant, such as through a service (“Agnostic Notification”) owned by the bank on fulfillment of an electronic payment request and the associated service. Because the financial intuition has an existing relationship with the user, and has user contact information, the financial institution may utilize specially customized transaction request messages to trigger the workflow provide the notification service. Thus, the user data is protected from third parties while enabling direct contact between the service provider or merchant and the user.

Based on such technical features, further technical benefits become available to users and operators of these systems and methods of the present disclosure. Moreover, various practical applications of the present disclosure are also described, which provide further practical benefits to users and operators that are also new and useful improvements in the art.

FIG. 1 is a block diagram of an exemplary computer-based system for an agnostic secure workflow service in accordance with one or more embodiments of the present disclosure.

In some embodiments, a user's account in an activity verification sub-system 120 may be leveraged to provide user-data based workflows to third-party entities while maintaining confidentiality of the user's data. The user-data based workflows can be performed contemporaneously with verification of an electronic activity relative to the user's account such that the third-party entity can provide additional activity-related services to the user without accessing the user's data. As a result, the user's data is kept secure. Moreover, parallel processing and resource use related to the electronic activity and addition activity-related service are made more efficient due to reduced duplication of processing and hardware components.

In some embodiments, to enable the user-data based workflows, a computer component including an initiator component 110 and the activity verification sub-system 120 utilize a specialized activity verification request 103 to leverage the existing user account 124 associated with the user. Using the specialized activity verification request 103, the initiator computer component 110 can interface with the activity verification sub-system 120 for data and token exchanges that enable the user-data based workflow to be provided as a service to the initiator component 110 without compromising (e.g., opening to cyber-attack, etc.) the user data in the account 124.

In some embodiments, the initiator component 110 may be a third-party computing device or system with which a user may use to initiate an electronic activity with the third-party. For example, the initiator component 110 may be, e.g., a social network server, cloud storage system, online payment system, point-of-sale device, website account server, or other system and/or device for electronic activities.

In some embodiments, the initiator component 110 may rely on an external activity verification sub-system 120, such as, e.g., a password service, a password management service, a social network, an identity management system, a financial institution system, or other suitable computer-based system that may manage and/or verifies user identity and user-related electronic activities. Accordingly, in some embodiments, upon the user entering into an electronic activity with the initiator component 110, an authorization request generator 111 of the initiator component 110 may be configured to receive electronic activity data, user data, third-party entity data, and/or other activity-related data. In some embodiments, the data may be provided, e.g., by user input via a user interface, by third-party input via the user interface, and/or being automatically generated based, at least in part, on electronic activity attribute(s), or a combination thereof.

In some embodiments, the user may input user identity data, such as, e.g., a user identifier (e.g., name), a user account identifier, a user credential (e.g., password, personal identification number (PIN), biometric login, among others and combinations thereof), and other user identity data. In some embodiments, one or more of the user identity data items may be automatically determined or received. For example, the user may present an authentication device for executing electronic activities, such as, e.g., a hardware authentication device, two-factor authentication device, identity or account card (e.g., credit card, debit card, personnel badge, etc.), or other device. Such a device may interact with the initiator component 110 to automatically provide user identity data and, in at least some embodiments, user credential data (e.g., cryptographic signatures, cryptographic keys, etc.).

In some embodiments, the user and/or the third-party entity may provide electronic activity details, such as, e.g., a third-party identifier, an initiator device identifier, an activity type, an activity operation, an activity value, an activity quantity, among other electronic activity details. In some embodiments, one or more of the electronic activity details may be automatically generated based on data input by the user or third-party entity or both. The authorization request generator 111 may be pre-programmed to generate one or more of the electronic activity details based on certain inputs by the user, third-party entity, or both. For example, the third-party entity may input a physical object effected by or otherwise associated with the electronic activity, and the authorization request generator 111 may automatically generate user-related, activity-related data such as the activity type, activity operation, activity value, and/or any other activity-related parameter (e.g., frequency, quantity, etc.) based on the physical object associated with the electronic activity.

In some embodiments, based on the electronic activity, certain workflows may be advantageous for providing data and information to the user, the third-party entity or both. For example, a status of a transaction for food or for an online purchase may be better communicated to the user through direct contact. In another example, a user profile creation at a website or social network may be made more efficient and secure by data sharing via an account or identity management system. Accordingly, based on, e.g., the activity type or activity operation or other suitable activity-related data item, the authorization request generator 111 may be configured to automatically generate a workflow identifier identifying a requested workflow service, workflow type identifier identifying a workflow type, or both.

In some embodiments, the authorization request generator 111 may be configured to generate the activity verification request 103 based on the activity-related data. Accordingly, the authorization request generator 111 may append the activity-related data and the workflow identifier or workflow type or both to an electronic message to form the activity verification request 103. The activity verification request 103 may have a format configured to provide the activity-related data to the activity verification sub-system 120 for verification of the electronic activity.

In some embodiments, the activity verification request 103 may be a structured data message having predetermined data fields for specifying corresponding data items, e.g., according to a messaging or message standard. For example, the activity verification request 103 may have one or more data fields for one or more of, e.g., the user identifier, the user account identifier, the user credential, the third-party identifier, the initiator device identifier, the activity type, the activity operation, the activity value, the activity quantity, the workflow identifier, the workflow type, or other data item or combinations thereof. As a result, the activity verification sub-system 120 may receive the activity verification request 103 and identify the authorization request to verify the electronic activity. In some embodiments, the data fields may conform to a standard, such as, e.g., an application programming interface (API) specification, standardized messaging structure (e.g., according to an International Organization for Standardization (ISO) standard), or other format for electronic messages. In some embodiments, the electronic message may be unstructured. In some embodiments, the standard may not include a data field for a workflow request. Accordingly, the initiator component 110 may be configured to generate electronic messages that employ customized one or more auxiliary data fields of the standard, such as data fields that are not dedicated to specific type of data or purpose or is reserved for other uses. The auxiliary data fields may be employed for specifying the workflow identifier or workflow type, or other workflow data and combinations thereof.

In some embodiments, the initiator component 110 may communicate the activity verification request 103 to the activity verification sub-system 120 to verify the electronic activity so that it may be executed or otherwise completed. In some embodiments, the activity verification request 103 may be communicated as an electronic message via any suitable messaging protocol or API, such as, e.g., a request-response or request-reply protocol, a publish-subscribe protocol, or any suitable communication protocol.

In some embodiments, the initiator component 110 and the activity verification sub-system 120 may communicate via wired or wireless interfaces. For example, the connection may be a wireless network connection, such as, a cellular network, WiFi, Bluetooth, Zigbee, Z-Wave, or other wireless network. In another example, the connection be a wired connection, such as, e.g., fiber optic, ethernet, coaxial, or other wired connection in a wired network such as, e.g., broadband, local area network, wide area network, or other suitable wired network. In some embodiments, the initiator component 110 and activity verification sub-system 120 may be in communication with each other via a combination of wired networks, wired connections, wireless networks and wireless connections.

In some embodiments, the activity verification sub-system 120 may receive the activity verification request 103 and concurrently verify the electronic activity and authorize a workflow service to provide a workflow functionality to the initiator component 110. In some embodiments, the activity verification sub-system 120 may be a part of the user computing device 101. Thus, the activity verification sub-system 120 may include hardware and software components including, e.g., user computing device 101 hardware and software, cloud or server hardware and software, or a combination thereof.

In some embodiments, the activity verification sub-system 120 may include hardware components such as a processor 122, which may include local or remote processing components. In some embodiments, the processor 122 may include any type of data processing capacity, such as a hardware logic circuit, for example an application specific integrated circuit (ASIC) and a programmable logic, or such as a computing device, for example, a microcomputer or microcontroller that include a programmable microprocessor. In some embodiments, the processor 122 may include data-processing capacity provided by the microprocessor. In some embodiments, the microprocessor may include memory, processing, interface resources, controllers, and counters. In some embodiments, the microprocessor may also include one or more programs stored in memory.

Similarly, the activity verification sub-system 120 may include storage 121, such as local hard-drive, solid-state drive, flash drive, database or other local storage, or remote storage such as a server, mainframe, database or cloud provided storage solution. In some embodiments, the storage 121 may maintain data for the activity verification sub-system 120. For example, accounts 124 managed by the account management service 130 may be stored in the storage 121 (e.g., in an account management database). Similarly, registered workflows executed as part of a workflow service may be indexed or otherwise defined and stored in a workflow library 123 in the storage 121. Other data and software of the activity verification sub-system 120 may be stored for on-demand access in the storage 121.

In some embodiments, the activity verification sub-system 120 may implement computer engines for an account management service 130 to manage accounts 124, a workflow management service 140 to authorize and manage the provision of a workflow service to the initiator component 110, and a tokenization service 150 to secure access to the workflow service via token-based credentials. In some embodiments, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some embodiments, the account management service 130 may utilize the activity verification request 103 to identify the account 124 associated with the user and verify that the electronic activity is authentic as being associated with the user. In order to implement the account management service 130, the account management service 130 may be include one or more computer engines that may include software components, hardware components, or a combination thereof. For example, each computer engine may include a dedicated processor and storage. In some embodiments, the computer engines share hardware resources, including the processor 122 and storage 121 of the activity verification sub-system 120 via, e.g., a bus. Thus, the account management service 130 may include a memory including software and software instructions, such as, e.g., account management and electronic activity verification, among other account-related functionalities.

In some embodiments, as described above, the activity verification request 103 may include a structured data format for recording the data related to the electronic activity for which verification is requested. In some embodiments the account management service 130 may parse the data of the activity verification request 103 to extract, e.g., the user identifier, the account identifier, or other identifier. In some embodiments, the activity verification request 103 may be an unstructured electronic message. Accordingly, the account management service 130 may utilize, e.g., natural language processing, or other technique for parsing unstructured data and automatically identifying the user identifier or account identifier.

In some embodiments, using the user identifier, account identifier, or other identifier, the account management service 130 may search the storage 121, e.g., using a suitable database query, text search, index look-up, or other search technique to identify and access the account 124 associated with the user participating in the electronic activity. As a result, the account management service 130 may associated the activity verification request 103 with the account 124 of the user.

Accordingly, in some embodiments, the account management service 130 may parse the data of the activity verification request 103 to extract the activity-related data. The activity-related data may be compared to data in the account 124 to determine whether the electronic activity is in fact associated with the user as opposed to a fraudulent or otherwise incorrect request, such as, e.g., a fraudulent transaction, an unverifiable login request, an impersonation in social media or fraudulent communication, among other unverifiable activities. Accordingly, data items such as, e.g., the activity type, the activity operation, the activity value or activity quantity, the activity date, the activity location, the third-party entity, among other data can be analyzed in view of user behaviors to determine whether the electronic activity is being performed by the user and not someone else.

In some embodiments, in order to verify the activity, the account management service 130 may use the activity-related data from the activity verification request 103 with, e.g., software logic or rules for similarity to data in, e.g., the user profile 125, verified history 126, activity history 127, among other data and combinations thereof. For example, in some embodiments, the account management service 130 may, e.g., use past user behaviors using data mining, machine learning, statistical analysis and other techniques. Alternatively, or additionally, the account management service 130 may use other verification techniques to ensure that the electronic activity is verified only when it is authentic and correct, including, e.g., using external authentication services and cryptographic authentication.

In some embodiments, based on the verification of the electronic activity associated with the activity verification request 103, the account management service 130 may append the activity verification to a response message 104. In some embodiments, before sending the response message 104 to the initiator component 110 for execution of the electronic activity, the account management service 130 may pass the verification, the response message 104 or both to the workflow management service 140 for workflow management. For example, the account management service 130 may place the verification or response message 104 or both into a cache or buffer for access by the workflow management service 140, or in any other suitable memory or storage, including, e.g., storage 121.

In some embodiments, upon verifying the electronic activity of the activity verification request 103, the workflow management service 140 may access the verification and the activity verification request 103 to identify an associated workflow and authenticate the workflow for the initiator component 110. In order to implement the workflow management service 140, the workflow management service 140 may be include one or more computer engines that may include software components, hardware components, or a combination thereof. For example, each computer engine may include a dedicated processor and storage. In some embodiments, the computer engines share hardware resources, including the processor 122 and storage 121 of the activity verification sub-system 120 via, e.g., a bus. Thus, the workflow management service 140 may include a memory including software and software instructions, such as, e.g., workflow management, workflow authentication and workflow execution, among other workflow management-related functionalities.

In some embodiments, the workflow management service 140 may parse the data of the activity verification request 103 to extract, e.g., the workflow type, the workflow identifier, or other identifier. In some embodiments, the activity verification request 103 may be an unstructured electronic message. Accordingly, the workflow management service 140 may utilize, e.g., natural language processing, or other technique for parsing unstructured data and automatically identifying the workflow type, the workflow identifier, or other identifier.

In some embodiments, using the workflow type and/or the workflow identifier, the workflow management service 140 may reference the workflow library 123, e.g., using a suitable database query, text search, index look-up, or other search technique to identify and access a registered workflow corresponding to the workflow associated with the activity verification request 103.

In some embodiments, the workflow management service 140 authorizes the initiator component 110 to access the identified workflow associated with the activity verification request 103. For example, in some embodiments, the workflow library 123 may include permissioned and/or participating third-party entities. Such permissioned or participating third-party entities may be specified in workflow records that define each workflow. For example, a workflow record can include attributes defining particular workflow, such as, e.g., a workflow type, a workflow identifier, a workflow function, third-party identifiers identifying permissioned or participating third-party entities, as well as any other suitable characteristics and attributes of each workflow. Based on the listed third-party identifiers in the record of the identified workflow of the activity verification request 103, the workflow management service 140 may authorize the third-party entity for access to the workflow functions via the activity verification sub-system 120.

In some embodiments, the workflow management service 140, may generate an indicator of the workflow verification. In some embodiments, based on this workflow verification, the initiator component 110 may request or otherwise trigger a workflow without accessing the user's data to be processed by the workflow. Accordingly, the workflow verification serves as a pre-authorization for access to the workflow service. In some embodiments, the workflow service may include a component of the workflow management service 140 or may be an external service to the workflow management service 140 that is initiated or otherwise managed by the workflow management service 140. For example, the workflow service may include, e.g., a cloud service (e.g., software-as-a-service (SaaS), function-as-a-service (FaaS), or other cloud-driven service), or may include a software service or engine included within the activity verification system.

In some embodiments, the indicator of workflow verification may be passed to the tokenization service 150 for generation of a secure and identifiable access token enabling the initiator component 110 to perform the request for the workflow. For example, the workflow management service 140 may place the indicator of workflow verification into a cache or buffer for access by the tokenization service 150, or in any other suitable memory or storage, including, e.g., storage 121.

In some embodiments, the tokenization service 150 may utilize the identified and authenticated workflow and the verified electronic activity to generate the secure token usable by the initiator component 110. In order to implement the tokenization service 150, the tokenization service 150 may be include one or more computer engines that may include software components, hardware components, or a combination thereof. For example, each computer engine may include a dedicated processor and storage. In some embodiments, the computer engines share hardware resources, including the processor 122 and storage 121 of the activity verification sub-system 120 via, e.g., a bus. Thus, the tokenization service 150 may include a memory including software and software instructions, such as, e.g., account management and electronic activity verification, among other account-related functionalities.

In some embodiments, the tokenization service 150 may access the indicator of the workflow verification as well as the workflow type or workflow identifier. In some embodiments, based on the indicator, the tokenization service 150 may generate a digital token that represents permission to request a workflow and access the workflow functionality. Thus, in some embodiments, the tokenization service 150 may generate, e.g., a one-time use token, such as, e.g., a one-time password, a cryptographic hash, a message authentication code (MAC), or other limited use token. For example, the tokenization service 150 may tokenize the indicator of the workflow verification using, e.g., a randomly generated value, a cryptographic hash of the indicator, or a combination of a cryptographic hash with the indicator and the randomly generated value. In an example, the tokenization may also include the third-party identifier, or a device identifier associated with the initiator component 110 in the cryptographic hash to, e.g., ensure the requester requesting a workflow is an authorized requester according to an identifier associated with the requester. Accordingly, the tokenization service 150 may produce tokens of varying security levels.

In some embodiments, the tokenization service 150 may generate and record the token and the associated electronic activity and/or workflow using, e.g., a distributed ledger such as a blockchain, including, e.g., Bitcoin, Ethereum, or other blockchain technologies. In some embodiments, the exemplary inventive computer-based systems/platforms, the exemplary inventive computer-based devices, and/or the exemplary inventive computer-based components of the present disclosure may be configured interact and/or to store data in one or more private and/or private-permissioned cryptographi cally-protected, distributed databased such as, without limitation, a blockchain (distributed ledger technology), Ethereum (Ethereum Foundation, Zug, Switzerland), and/or other similar distributed data management technologies. For example, as utilized herein, the distributed database(s), such as distributed ledgers ensure the integrity of data by generating a chain of data blocks linked together by cryptographic hashes of the data records in the data blocks. For example, a cryptographic hash of at least a portion of data records within a first block, and, in some cases, combined with a portion of data records in previous blocks is used to generate the block address for a new digital identity block succeeding the first block. As an update to the data records stored in the one or more data blocks, a new data block is generated containing respective updated data records and linked to a preceding block with an address based upon a cryptographic hash of at least a portion of the data records in the preceding block. In other words, the linked blocks form a blockchain that inherently includes a traceable sequence of addresses that can be used to track the updates to the data records contained therein. The linked blocks (or blockchain) may be distributed among multiple network nodes within a computer network such that each node may maintain a copy of the blockchain. Malicious network nodes attempting to compromise the integrity of the database must recreate and redistribute the blockchain faster than the honest network nodes, which, in most cases, is computationally infeasible. In other words, data integrity is guaranteed by the virtue of multiple network nodes in a network having a copy of the same blockchain. In some embodiments, as utilized herein, a central trust authority for sensor data management may not be needed to vouch for the integrity of the distributed database hosted by multiple nodes in the network.

In some embodiments, the exemplary distributed blockchain-type ledger implementations of the present disclosure with associated devices may be configured to affect transactions involving Bitcoins and other cryptocurrencies into one another and also into (or between) so-called FIAT money or FIAT currency and vice versa.

In some embodiments, the exemplary distributed blockchain-type ledger implementations of the present disclosure with associated devices are configured to utilize smart contracts that are computer processes that facilitate, verify and/or enforce negotiation and/or performance of one or more particular activities among users/parties. For example, an exemplary smart contract may be configured to be partially or fully self-executing and/or self-enforcing. In some embodiments, the exemplary inventive asset-tokenized distributed blockchain-type ledger implementations of the present disclosure may utilize smart contract architecture that can be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. For example, each node may also check the work of other nodes and in some cases, as noted above, function as miners or validators.

In some embodiments, in order to ensure the initiator component 110 accesses only the workflow for which it is authorized, the tokenization service 150 may link the token to the workflow. For example, in some embodiments, the activity verification sub-system 120 may include, e.g., an index, library, look-up-table, blockchain or other data structure to catalog the token and the associated workflow, as well as any other suitable data, such as, e.g., the third-party identifier, the initiator device identifier, the activity identifier or activity type, the user identifier, among any other suitable data.

In some embodiments, the tokenization service 150 may append the token to the response message 104 with the activity verification. In some embodiments, the response message 104 may, therefore, serve to authorize execution of the electronic activity as well as to provide credentials for the initiator component 110 to request the workflow and access the workflow functions and/or results according to the workflow service.

In some embodiments, the initiator component 110 may receive the response message 104 and execute the electronic activity based on the activity verification by the account management service 130. In some embodiments, the electronic activity may be enhanced by third-party software and service functionalities that provide value to the user. Such functionalities may require user data or user information, thus presenting a vector for data compromise or misuse. Accordingly, to provide the functionality to the user without knowing or accessing the user data, the initiator component 110 may utilize the token in the response message 104 to formulate a workflow request.

In some embodiments, the initiator component 110 may include a workflow request generator 112 that formulates the workflow request 105 based on trigger conditions to convey the trigger conditions. In some embodiments, depending on the electronic activity being executed, the functionalities may be responsive to certain conditions. For example, in a food service transaction, the trigger conditions may be the food being ready to serve or ready for pickup or other status and combinations thereof. Similarly, for an online ordering transaction, the trigger condition may include a shipment of the online order or other status and combinations thereof. In some embodiments, where the trigger conditions are satisfied, the workflow request generator 112 may generate the workflow request 105 and append the token, the trigger conditions, as well as, e.g., the workflow identifier, the user identifier, the initiator device identifier, the third-party identifier, the activity type, the activity operation, or other activity-related data and combinations thereof.

In some embodiments, the workflow request 105 may be sent to a workflow trigger 128. In some embodiments, the workflow trigger 128 may include, e.g., an API, a messaging adapter, or other software processor or system to cause the workflow to be executed. In some embodiments, the workflow request generator 112 may provide the workflow request 105 to the workflow trigger 128 via a suitable API call.

In some embodiments, the workflow trigger 128 receives the workflow request 105 and extracts the token and the activity-related data. Using the token and the activity-related data, the workflow trigger 128 interfaces with the workflow management service 140 to instantiate the workflow service and execute the workflow.

In some embodiments, the workflow service may validate the workflow request 105 based on the token. For example, the token may be compared to the token specified in the data structure cataloging the token and the associated workflow. For example, the workflow management service 140 may compare the activity-related data or workflow identifier of the workflow request 105 to the data structure and identify the corresponding token. The token of the workflow request 105 may then be compared to the token specified in the data structure to validate a match and execute the workflow. In some embodiments, the token may include a cryptographic hash based on, e.g., the third-party identifier, the device identifier, the user identifier, or other information as described above. Accordingly, the workflow management service 140 may validate the token based on a cryptographic hash of the third-party identifier, the device identifier, the user identifier, or other information specified in the workflow request. Other validation techniques are also contemplated.

In some embodiments, upon validation, the workflow management service 140 may manage the workflow service to execute the appropriate workflow using user data stored in the user profile 125, such as, e.g., contact information or other user information. In some embodiments, the results from the workflow may be provided to the workflow trigger 128, which may, in turn, perform the workflow functionality such as, e.g., issuing a notification 106 to a user computing device 101. For example, the workflow may generate a status update notification that notifies the user of the status of the electronic activity. The status update notification may then be sent to the user computing device 101 according to the user's contact information in the user profile 125 while protecting the contact information from third-party access and improving convenience for the user.

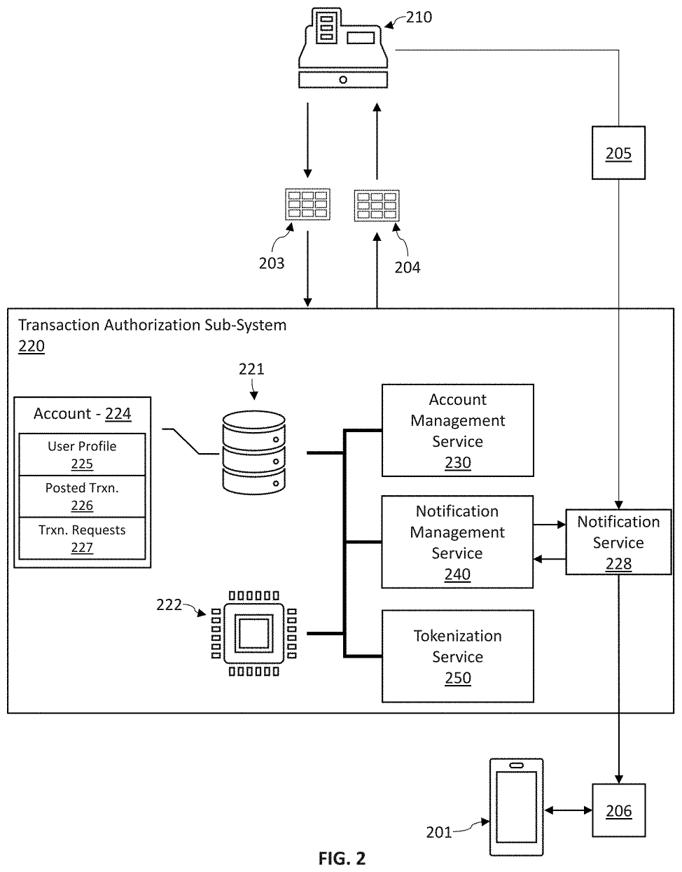

FIG. 2 is a block diagram of another exemplary computer-based system for an agnostic secure workflow service including an agnostic secure notification service in accordance with one or more embodiments of the present disclosure.

In some embodiments, a user's account in a transaction authorization sub-system 220 may be leveraged to provide direct communications to a user from third-party entities while maintaining confidentiality of the user's data. The direct communication workflows can be performed contemporaneously with verification of a transaction relative to the user's account such that the third-party entity can provide transaction status notifications to the user without accessing the user's data. As a result, the user's data is kept secure. Moreover, processing and resource use related to the electronic activity and addition activity-related service are made more efficient due to reduced duplication of processing and hardware components.

In some embodiments, to enable the user-data based workflows, a point-of-sale device 210 and the transaction authorization sub-system 220 utilize a specialized authorization request 203 to leverage the existing account 224 associated with the user. Using the specialized authorization request 203, the point-of-sale device 210 can interface with the transaction authorization sub-system 220 for data and token exchanges that enable the user-data based workflow to provide as a service to the point-of-sale device 210 without disclosing user data or allowing the user data to be read, or otherwise compromising the user data in the account 224.

In some embodiments, the point-of-sale device 210 may be configured to utilize a custom bit number of a transaction authorization request to enter a request for notification service access. For example, transactions may be requested using the ISO 8583 standard for Card Messages, and enter the request for notification service access into, e.g., Bit 63, an auxiliary data field reserved for private use. Here, Bit 63 may be employed to exchange notification service requests concurrently with transaction authorization requests. Thus, the electronic message for the requesting transaction authorizations is customized to enable interfacing between the point-of-sale device 210 and the transaction authorization sub-system 220 to provide notification functionality to the point-of-sale device 210 without access to any user data. Thus, the security and confidentiality of the user data is improved, duplication of resources for the user data is reduced, and fewer data inputs and exchanges can be used to initiate notifications to the user.

In some embodiments, the authorization request 203 may include transaction data according to the message standard (e.g., ISO 8583 or other suitable standard), including, e.g., a user account identifier, a merchant identifier, a merchant category or type (e.g., Merchant Category Code (MCC)), a point-of-sale device identifier, a transaction type, a transaction operation, a transaction value, among other transaction details.

In some embodiments, the point-of-sale device 210 may communicate the authorization request 203 to the transaction authorization sub-system 220 to verify the transaction so that it may be executed or otherwise completed. In some embodiments, the authorization request 203 may be communicated as an electronic message via any suitable messaging protocol or API, such as, e.g., a request-response or request-reply protocol, a publish-subscribe protocol, or any suitable communication protocol.

In some embodiments, the point-of-sale device 210 and the transaction authorization sub-system 220 may communicate via wired or wireless interfaces. For example, the connection may be a wireless network connection, such as, a cellular network, WiFi, Bluetooth, Zigbee, Z-Wave, or other wireless network. In another example, the connection be a wired connection, such as, e.g., fiber optic, ethernet, coaxial, or other wired connection in a wired network such as, e.g., broadband, local area network, wide area network, or other suitable wired network. In some embodiments, the point-of-sale device 210 and transaction authorization sub-system 220 may be in communication with each other via a combination of wired networks, wired connections, wireless networks and wireless connections.

In some embodiments, the transaction authorization sub-system 220 may receive the authorization request 203 and concurrently verify the transaction and authorize a notification service to provide a notification service functionality to the point-of-sale device 210. In some embodiments, the transaction authorization sub-system 220 may be a part of the user computing device 201. Thus, the transaction authorization sub-system 220 may include hardware and software components including, e.g., user computing device 201 hardware and software, cloud or server hardware and software, or a combination thereof.

In some embodiments, the transaction authorization sub-system 220 may include hardware components such as a processor 222, which may include local or remote processing components. In some embodiments, the processor 222 may include any type of data processing capacity, such as a hardware logic circuit, for example an application specific integrated circuit (ASIC) and a programmable logic, or such as a computing device, for example, a microcomputer or microcontroller that include a programmable microprocessor. In some embodiments, the processor 222 may include data-processing capacity provided by the microprocessor. In some embodiments, the microprocessor may include memory, processing, interface resources, controllers, and counters. In some embodiments, the microprocessor may also include one or more programs stored in memory.

Similarly, the transaction authorization sub-system 220 may include storage 221, such as local hard-drive, solid-state drive, flash drive, database or other local storage, or remote storage such as a server, mainframe, database or cloud provided storage solution. In some embodiments, the storage 221 may maintain data for the transaction authorization sub-system 220. For example, accounts 224 managed by the account management service 230 may be stored in the storage 221 (e.g., in an account management database). Other data and software of the transaction authorization sub-system 220 may be stored for on-demand access in the storage 221.

In some embodiments, the transaction authorization sub-system 220 may implement computer engines for an account management service 230 to manage accounts 224, a notification management service 240 to authorize and manage the provision of a notification service to the point-of-sale device 210, and a tokenization service 250 to secure access to the notification service via token-based credentials. In some embodiments, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

In some embodiments, the account management service 230 may utilize the authorization request 203 to identify the account 224 associated with the user and verify that the transaction is authentic and verified as being associated with the user. In order to implement the account management service 230, the account management service 230 may include one or more computer engines that may include software components, hardware components, or a combination thereof. For example, each computer engine may include a dedicated processor and storage. In some embodiments, the computer engines share hardware resources, including the processor 222 and storage 221 of the transaction authorization sub-system 220 via, e.g., a bus. Thus, the account management service 230 may include a memory including software and software instructions, such as, e.g., account management and transaction verification, among other account-related functionalities.

In some embodiments, using the user identifier, account identifier, or other identifier, the account management service 230 may search the storage 221, e.g., using a suitable database query, text search, index look-up, or other search technique to identify and access the account 224 associated with the user participating in the transaction. As a result, the account management service 230 may associated the authorization request 203 with the account 224 of the user.

Accordingly, in some embodiments, the account management service 230 may parse the data of the authorization request 203 to extract the transaction data. The transaction data may be compared to data in the account 224 to determine whether the transaction is in fact associated with the user as opposed to a fraudulent or otherwise incorrect transaction request.

In some embodiments, in order to authorize the activity, the account management service 230 may use the transaction data from the authorization request 203 with, e.g., software logic or rules for similarity to data in, e.g., the user profile 225, posted transactions 226, transaction requests 227, among other data and combinations thereof. For example, in some embodiments, the account management service 230 may, e.g., use past user behaviors using data mining, machine learning, statistical analysis and other techniques. Alternatively, or additionally, the account management service 230 may use other authorization techniques to ensure that the transaction is verified only when it is authentic and correct, including, e.g., using external authentication services and cryptographic authentication.

In some embodiments, based on the authorization of the transaction associated with the authorization request 203, the account management service 230 may append the transaction authorization to a response message 204. In some embodiments, before sending the response message 204 to the point-of-sale device 210 for execution of the transaction, the account management service 230 may pass the verification, the response message 204 or both to the notification management service 240 for notification service management. For example, the account management service 230 may place the verification or response message 204 or both into a cache or buffer for access by the notification management service 240, or in any other suitable memory or storage, including, e.g., storage 221.

In some embodiments, upon authorizing the transaction of the authorization request 203, the notification management service 240 may access the authorization and the authorization request 203 to identify an associated notification service and authenticate the notification service for the point-of-sale device 210. In order to implement the notification management service 240, the notification management service 240 may be include one or more computer engines that may include software components, hardware components, or a combination thereof. For example, each computer engine may include a dedicated processor and storage. In some embodiments, the computer engines share hardware resources, including the processor 222 and storage 221 of the transaction authorization sub-system 220 via, e.g., a bus. Thus, the notification management service 240 may include a memory including software and software instructions, such as, e.g., notification service management, notification service authentication and notification service execution, among other notification service management-related functionalities.

In some embodiments, the notification management service 240 authorize the point-of-sale device 210 to access the notification service associated with the authorization request 203. For example, in some embodiments, the notification management service 240 may include permissioned or participating third-party entities. Such permissioned or participating third-party entities may be specified in notification service records. For example, a notification service record can include attributes defining, e.g., a notification service type (e.g., email, text, internet messaging, push notification, etc.), third-party identifiers identifying permissioned or participating third-party entities, as well as any other suitable characteristics and attributes of the notification service. Based on the listed third-party identifiers in the record, the notification management service 240 may authorize the third-party entity for access to the notification service functions via the transaction authorization sub-system 220.

In some embodiments, the notification management service 240, may generate an indicator of the notification service verification. In some embodiments, based on this notification service verification, the point-of-sale device 210 may request or otherwise trigger a notification service without accessing the user's data to be processed by the notification service. Accordingly, the notification service verification serves a pre-authorization for access to the notification service. In some embodiments, the notification service may include a component of the notification management service 240 or may be an external service to the notification management service 240 that is initiated or otherwise managed by the notification management service 240. For example, the notification service may include, e.g., a cloud service (e.g., software-as-a-service (SaaS), function-as-a-service (FaaS), or other cloud-driven service), or may include a software service or engine included within the transaction authentication system.

In some embodiments, the indicator of notification service verification may be passed to the tokenization service 250 for generation of a secure and identifiable access token enabling the point-of-sale device 210 to perform the request for the notification service. For example, the notification management service 240 may place the indicator of notification service verification into a cache or buffer for access by the tokenization service 250, or in any other suitable memory or storage, including, e.g., storage 221.

In some embodiments, the tokenization service 250 may utilize the identified and authenticated notification service and the verified transaction to generate the secure token usable by the point-of-sale device 210. In order to implement the tokenization service 250, the tokenization service 250 may be include one or more computer engines that may include software components, hardware components, or a combination thereof. For example, each computer engine may include a dedicated processor and storage. In some embodiments, the computer engines share hardware resources, including the processor 222 and storage 221 of the transaction authorization sub-system 220 via, e.g., a bus. Thus, the tokenization service 250 may include a memory including software and software instructions, such as, e.g., account management and transaction authorization, among other account-related functionalities.

In some embodiments, the tokenization service 250 may access the indicator of the notification service verification as well as the notification service type or notification service function. In some embodiments, based on the indicator, the tokenization service 250 may generate a token that represents permission to request a notification service and access the notification service functionality. Thus, in some embodiments, the tokenization service 250 may generate, e.g., a one-time use token, such as, e.g., a one-time password, a cryptographic hash, a message authentication code (MAC), or other limited use token. For example, the tokenization service 250 may tokenize the indicator of the notification service verification using, e.g., a randomly generated value, a cryptographic hash of the indicator, or a combination of a cryptographic hash with the indicator and the randomly generated value. In an example, the tokenization may also include the third-party identifier, or a device identifier associated with the point-of-sale device 210 in the cryptographic hash to, e.g., ensure the requester requesting a notification service is an authorized requester according to an identifier associated with the requester. Accordingly, the tokenization service 250 may produce tokens of varying security levels.

In some embodiments, the tokenization service 250 may append the token to the response message 204 with the transaction authentication. In some embodiments, the response message 204 may, therefore, serve to authorize execution of the transaction as well as to provide credentials for the point-of-sale device 210 to request the notification service and access the notification service functions and/or results according to the notification service.

In some embodiments, the point-of-sale device 210 may receive the response message 204 and execute the transaction based on the transaction authentication by the account management service 230. In some embodiments, the transaction may be enhanced by third-party software and service functionalities that provide value to the user. Such functionalities may require user data or user information, thus presenting a vector for data compromise or misuse. Accordingly, to provide the functionality to the user without knowing or accessing the user data, the point-of-sale device 210 may utilize the token in the response message 204 to formulate a notification service request.

In some embodiments, the point-of-sale device 210 may formulate the notification service request 205 based on trigger conditions to convey the trigger conditions. In some embodiments, depending on the transaction being executed, the functionalities may be responsive to certain conditions. For example, in a food service transaction, the trigger conditions may be the food being ready to serve or ready for pickup or other status and combinations thereof. Similarly, for an online ordering transaction, the trigger condition may include a shipment of the online order or other status and combinations thereof In some embodiments, where the trigger conditions are satisfied, the notification service request generator may generate the notification service request 205 and append the token, the trigger conditions, as well as, e.g., the notification service functionality, the user identifier, the initiator device identifier, the third-party identifier, the activity type, the activity operation, or other transaction data and combinations thereof.

In some embodiments, the notification service request 205 may be sent to a notification service 228. In some embodiments, the notification service 228 may include, e.g., an API, a messaging adapter, or other software processor or system to cause the notification service to be executed. In some embodiments, the notification service request generator may provide the notification service request 205 to the notification service 228 via a suitable API call.

In some embodiments, the notification service 228 receives the notification service request 205 and extracts the token and the transaction data. Using the token and the transaction data, the notification service 228 interfaces with the notification management service 240 to instantiate the notification service and execute the notification service.

In some embodiments, the notification service may validate the notification service request 205 based on the token. For example, the token may be compared to the token issued by the tokenization service 250 for the point-of-sale device 210. For example, the notification service management service 240 may compare the transaction data or notification service identifier of the notification service request 205 to the data structure and identify the corresponding token. The token of the notification service request 205 may then be compared to the token specified in the data structure to validate a match and execute the notification service. In some embodiments, the token may include a cryptographic hash based on, e.g., the merchant identifier, the device identifier, the user identifier, or other information as described above. Accordingly, the notification service management service 240 may validate the token based on a cryptographic hash of the merchant identifier, the device identifier, the user identifier, or other information specified in the notification service request. Other validation techniques are also contemplated.

In some embodiments, upon validation, the notification service management service 240 may manage the notification service to execute the notification service using user data stored in the user profile 225, such as, e.g., contact information or other user information. In some embodiments, the results from the notification service may be provided to the notification service 228, which may, in turn, perform the notification service functionality such as, e.g., issuing a notification 206 to a user computing device 201 via, e.g., push notification from an application associated with the transaction authorization sub-system 220, an email, a text message, a social media post, an internet messaging message, etc. For example, the notification service may generate a status update notification that notifies the user of the status of the transaction. The status update notification may then be sent to the user computing device 201 according to the user's contact information in the user profile 225 while protecting the contact information from third-party access and improving convenience for the user.

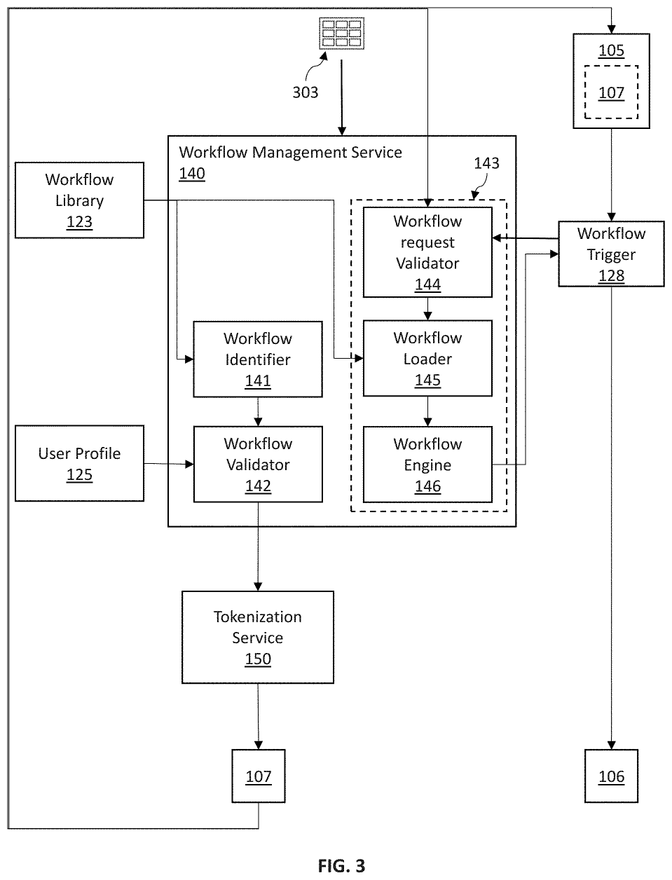

FIG. 3 is a block diagram of another exemplary computer-based system for an agnostic secure workflow service using a workflow management service in accordance with one or more embodiments of the present disclosure.

In some embodiments, the workflow management service 140 may receive an electronic message 303 including an activity verification request from an initiator device. In some embodiments, the initiator device is associated with an entity with which a user is engaging in an electronic activity.

In some embodiments, the activity verification request includes data fields based on a message standard. For example, some request messages include standard data structures with standard data fields depending on the service provider (e.g., an operator of the systems and services associated with the workflow management service 140). For example, card messages for transactions typically conform to ISO 8583. Some standards are industry standards, and some are manufacturer, operator, vendor or technology specific.

In some embodiments, the message standard may include one or more auxiliary data fields not dedicated to any particular data type, such as private user data fields. In some embodiments, the electronic message 303 may include such auxiliary data fields, which are adapted to requesting secure workflows for providing functionality to the entity and the user. Thus, the electronic message 303 includes a specialized and customized adaptation to a message standard to enable the requesting of secure workflows that are not original included within the message standard.

In some embodiments, the auxiliary data field of the electronic message 303 includes a workflow request indicating a secure workflow for providing a service to the user in a secure manner that maintains user data confidentiality. In some embodiments, a workflow identifier 141 of the workflow management service 140 may utilize the auxiliary data field to extract a workflow identifier of the workflow request. Using the data in the auxiliary data field, the workflow identifier 141 may consult a workflow library 123 to identify an associated workflow file. The workflow file may include, e.g., a secure workflow, workflow type data, workflow permissions data, among other workflow data and information for each registered workflow registered with the workflow management service 140 and stored in the workflow library 123. Thus, the workflow identifier 141 can identify and access the particular secure workflow associated with the electronic message 303 and associated workflow request.

In some embodiments, once identified, a workflow validator 142 can validate the workflow for access by the entity. In some embodiments, the workflow validator 142 may authorize the initiator to access the identified workflow associated with the activity verification request. For example, in some embodiments, the workflow library 123 may include permissioned or participating third-party entities. Such permissioned or participating third-party entities may be specified in workflow records that define each workflow. For example, a workflow record can include attributes defining particular workflow, such as, e.g., a workflow type, a workflow identifier, a workflow function, third-party identifiers identifying permissioned or participating third-party entities, as well as any other suitable characteristics and attributes of each workflow. Based on the listed third-party identifiers in the record of the identified workflow of the activity verification request, the workflow validator 142 may authorize the entity for access to the workflow functions.

In some embodiments, the workflow management service 140 include a workflow service 143 that instantiates and executes the identified workflow. In some embodiments, the instantiation of the workflow service 143 for the identified workflow is subject to authentication of the initiation device, e.g., via a one-time token. Thus, the access to the workflow functionality can be secured against misuse.

In some embodiments, the tokenization service 150 can produce the one-time token 107 for authenticating the initiating device. In some embodiments, the tokenization service 150 based on the verification of the workflow by the workflow validator 142, the tokenization service 150 may generate a one-time token 107 that represents permission for the initiating device to request a workflow and access the workflow functionality. Thus, in some embodiments, the tokenization service 150 may generate a device-specific one-time use token 107, such as, e.g., a one-time password, a cryptographic hash, a message authentication code (MAC), or other limited use token. For example, the tokenization service 150 may tokenize workflow-related data using, e.g., a randomly generated value, a cryptographic hash of the indicator, a blockchain or a combination of a cryptographic hash with an indicator of the validation of the workflow, a workflow identifier, a the randomly generated value, among other factors and combinations thereof. In an example, the tokenization may also include an entity identifier identify the entity associated with the initiating device, or a device identifier associated with the initiating device in the cryptographic hash to, e.g., ensure the requester requesting a workflow is an authorized requester according to an identifier associated with the requester.

In some embodiments, in order to ensure the initiating device accesses only the workflow for which it is authorized and that only the initiating device accesses the workflow, the tokenization service 150 may link the token to the workflow. Thus, the one-time token 107 includes a device-specific workflow token for a workflow service 143 to execute a device-specific instance of the secure workflow. For example, in some embodiments, the activity verification sub-system 120 and/or the workflow management service 140 may include, e.g., an index, library, look-up-table, a blockchain or other data structure to catalog the token and the associated workflow, as well as any other suitable data, such as, e.g., the third-party identifier, the initiator device identifier, the activity identifier or activity type, the user identifier, among any other suitable data.

In some embodiments, the initiating device may then use the one-time token 107 in a workflow request 105 to actuate the workflow trigger 128. In some embodiments, the workflow trigger 128 receives the workflow request 105 including an indication of trigger conditions, such as, e.g., a transaction fulfillment or transaction status change, or other trigger condition. The workflow request 105 may also include an identification of the requested workflow among other suitable information.

In some embodiments, the workflow trigger 128 may utilize the one-time token 107, the trigger conditions, and the identification of the workflow to trigger the instantiation of the workflow service 143. In some embodiments, the instance of the workflow service 143 may be specific to the workflow request 105, e.g., the workflow service 143 is instantiated in response to the workflow request 105 for processing the workflow request 105 from the initiating device. Thus, the workflow service 143 to executes a device-specific instance of the secure workflow requested in the workflow request 105.

In some embodiments, a workflow request validator 144 of the workflow service 143 may utilize the one-time token 107 and the indication of the requested workflow to validate the workflow request 105. In particular, the workflow request validator 144 may receive the one-time token 107 from the tokenization service 150 for comparison to the one-time token 107 of the workflow request 105. For example, the token may be compared to the token specified by the workflow validator 142 and the indicated workflow. To validate the workflow request 105, the workflow request validator 144 may assess a match between the one-time token 107 from the tokenization service 150 and the one-time token 107 of the workflow request 105.

In some embodiments, upon validating the one-time token 107 of the workflow request 105, the initiating device may be authenticated for accessing the functionality of the requested workflow. Accordingly, in some embodiments, the workflow service 143 may then execute a workflow loader 145 to identify and load the secure workflow from the workflow library 123 that matches the request and/or the cryptographic hash forming the one-time token 107. In some embodiments, the workflow loader 145 may utilize the workflow identifier to reference the workflow library 123, e.g., according to a look-up-table, index, database query, search, or other suitable technique. In some embodiments, the entry in the workflow library 123 associated with the secure workflow may store or otherwise link to the secure workflow. For example, the secure workflow may be a locally stored or cloud service stored software program that is loaded by the workflow library 123. In other examples, the secure workflow may be an external service that is called using, e.g., a suitable API request by the entry in the workflow library 123. Other techniques for loading the software functionality associated with the secure workflow are also contemplated.

In some embodiments, upon loading the secure workflow for providing functionality on behalf of the initiating device, a workflow engine 146 may execute the secure workflow. Accordingly, an instance of the secure workflow is created and executed on behalf of the initiating device to provide a device-specific secure workflow.

In some embodiments, the secure workflow, when executed, may perform user data related operations on behalf of the initiating device. Thus, user data related operations may be triggered by the initiating device without the initiating device handling or accessing the user data, maintaining security of the user data. Because the activity verification system hosting the workflow management service 140 and the workflow service 143 has an existing relationship with the user, including an existing user profile with, e.g., contact information as well as other user information, the activity verification system may leverage that relationship to enable the entity to provide services to the user without the entity having the infrastructure or user data to do so, thus improving functionality of the initiating device by operating on its behalf upon receipt of a valid workflow request 105.

In some embodiments, to further improve the security of the user data, the workflow engine 146 may be permissioned to access confidentially stored user data, such as, e.g., an encrypted user profile or other encrypted user data. Such encrypted data may be inaccessible to outside devices, ensuring security and confidentiality.

In some embodiments, the workflow engine 146 may execute the secure workflow according to the workflow request 105, which may specify, e.g., an activity status related to a status of the electronic activity. For example, transaction or service fulfillment statuses, order fulfillment statuses, multi-factor authentication token statuses, among other statuses associated with performance and fulfillment of the electronic activity. Accordingly, the workflow engine 146 may apply the activity status to the secure workflow to generate a notification 106 including, e.g., a status notification 206 to notify a user of the activity status. For example, where the activity status includes a transaction fulfillment status, the secure workflow may generate a status notification 206 including, e.g., an indication of the fulfillment status such as, e.g., processing, shipped, delivered, ready to serve, served, or other status. In another example, where the activity status includes a multifactor authentication token status, the secure workflow may generate a status notification 206 including, e.g., a multifactor authentication token, an amount of time left for token validity, among other multifactor authentication token status information. In some embodiments, the secure workflow may also generate the multifactor authentication token in addition to the notification regarding the token. In some embodiments, the secure workflow may look up or reference an externally generated multifactor authentication token.

In some embodiments, the workflow engine 146 using the secure workflow may generate the status notification 206 and determine user contact information. In some embodiments, the user contact information may include, e.g., an email address, a social media account, a device ID for push notifications, a telephone number (e.g., for an automated voice call or an automated text message), an internet messaging account, or other contact information. In some embodiments, the contact information may also include, e.g., user contact preferences. For example, the contact information in the user profile may be selectable by the user to include modes of communication (e.g., email, text message, phone call, internet message, social media, push notification, etc.). The selected modes of communication may be a global preference (e.g., for all communications and notifications), or may be specified for types of communications or sources of the communications. For example, the user profile may include a user specified contact preference for the entity associated with the initiating device. Accordingly, the workflow engine 146 may use the device identifier and/or entity identifier to determine the matching user preference to the entity.

In some embodiments, based on the contact information from the user profile 125, the workflow engine may transmit the status notification 206 to the user device via the workflow trigger 128, e.g., using an associated API request or by another suitable mechanism. Accordingly, the workflow trigger 128 may provide the status notification 206 to the user on behalf of the initiating device based on information provided by the initiating device while maintaining security and confidentiality of the user data.

In some embodiments, the workflow trigger 128 may alternatively or additionally provide the status notification 206 to the initiating device. For example, in some scenarios the user may be located at the initiating device. As a result, the status notification 206 may be advantageously delivered to the initiating device to alert the user while at the initiating device's location, increasing the likelihood that the user receives the status notification 206.

In some embodiments, because the one-time token 107 is tied to the workflow validated for the initiating device and the electronic activity, the one-time token 107 may expire upon transmission of the status notification 206. In some embodiments, the expiration may be a result of a time limit elapsing, by the workflow engine 146 deleting the one-time token 107, by the one-time token 107 include a hash as a function of a date of authorization, electronic activity identifier, or other data unique to the electronic activity for which the status notification 206 is issued.

Accordingly, the workflow management service 140 may securely and efficiently provide functionality using user data on behalf of an initiating device to enhance initiating device functionality while maintaining security and confidentiality of user data.

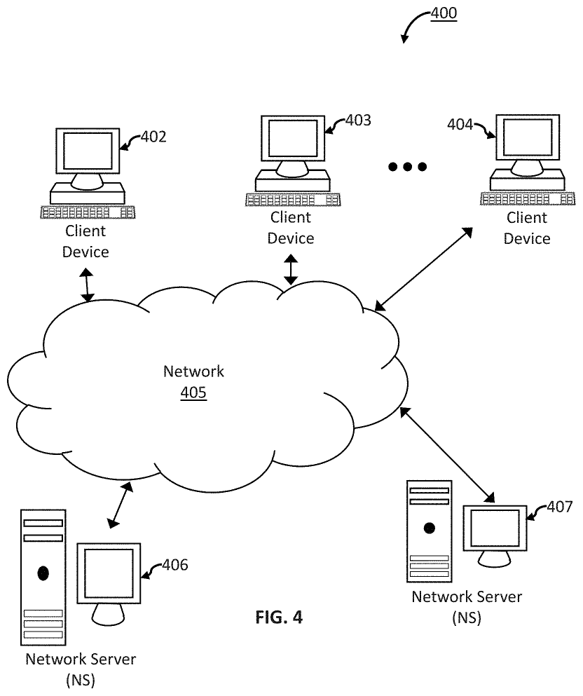

FIG. 4 depicts a block diagram of an exemplary computer-based system and platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 400 may be configured to manage a large number of members and concurrent transactions, as detailed herein. In some embodiments, the exemplary computer-based system and platform 400 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 4, member computing device 402, member computing device 403 and member computing device 404 (e.g., clients) of the exemplary computer-based system and platform 400 may include virtually any computing device capable of receiving and sending a message over a network (e.g., cloud network), such as network 405, to and from another computing device, such as servers 406 and 407, each other, and the like. In some embodiments, the member computing devices 402 through 404 may be personal computers, multiprocessor systems, microprocessor-based or programmable consumer electronics, network PCs, and the like. In some embodiments, one or more member computing devices within member computing devices 402 through 404 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member computing devices within member computing devices 402-404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member computing devices within member computing devices 402 through 404 may include may run one or more applications, such as Internet browsers, mobile applications, voice calls, video games, videoconferencing, and email, among others. In some embodiments, one or more member computing devices within member computing devices 402 through 404 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member computing device within member computing devices 402-404 may be specifically programmed by either Java, .Net, QT, C, C++ and/or other suitable programming language. In some embodiments, one or more member computing devices within member computing devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as network attached storage (NAS), a storage area network (SAN), a content delivery network (CDN) or other forms of computer or machine readable media.

In some embodiments, the exemplary server 406 or the exemplary server 407 may be a web server (or a series of servers) running a network operating system, examples of which may include but are not limited to Microsoft Windows Server, Novell NetWare, or Linux. In some embodiments, the exemplary server 406 or the exemplary server 407 may be used for and/or provide cloud and/or network computing. Although not shown in FIG. 4, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing device 402, member computing device 403 through member computing device 404.

In some embodiments and, optionally, in combination of any embodiment described above or below, for example, one or more exemplary computing member computing devices 402 through 404, the exemplary server 406, and/or the exemplary server 407 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof

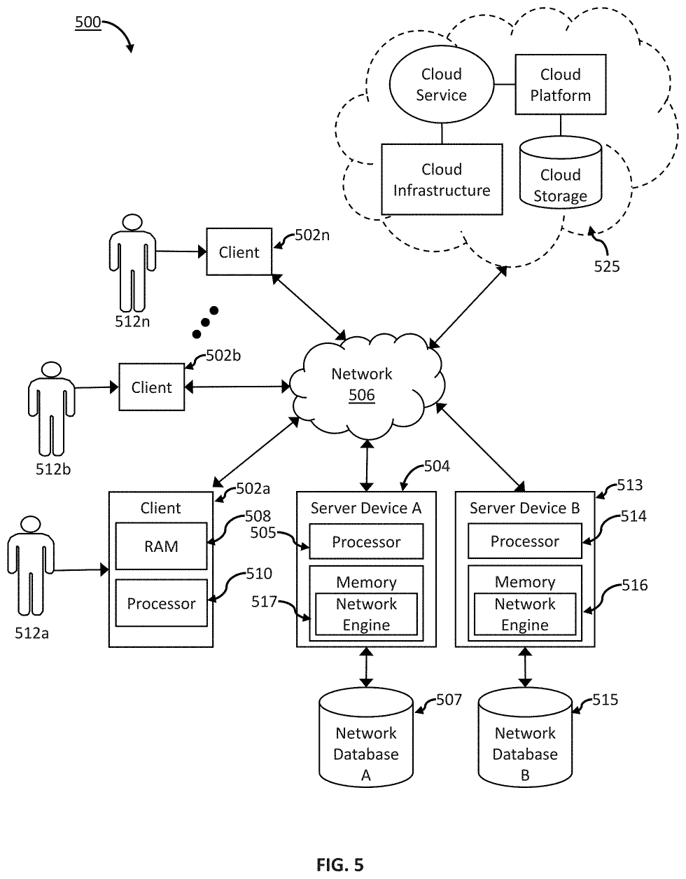

FIG. 5 depicts a block diagram of another exemplary computer-based system and platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 502a, 502b thru 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of member computing device 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 502a through 502n may also comprise a number of external or internal devices such as a mouse, a CD-ROM, DVD, a physical or virtual keyboard, a display, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing device 502a, member computing device 502b through member computing device 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™, Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, user 512a, user 512b through user 512n, may communicate over the exemplary network 506 with each other and/or with other systems and/or devices coupled to the network 506. As shown in FIG. 5, exemplary server device 504 and server device 513 may be also coupled to the network 506. Server device 504 may include processor 505 and memory 517, and server 513 may include processor 514 and memory 516. In some embodiments, one or more member computing devices 502a through 502n may be mobile clients.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

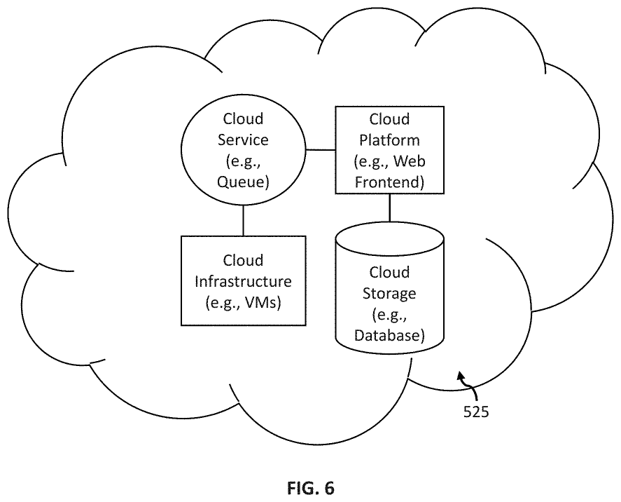

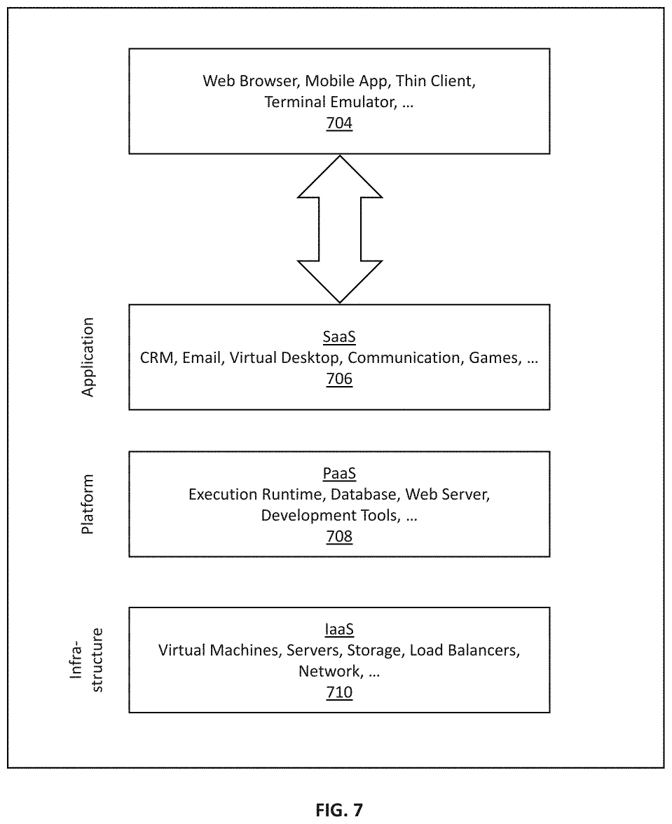

In some embodiments, the exemplary inventive computer-based systems/platforms, the exemplary inventive computer-based devices, and/or the exemplary inventive computer-based components of the present disclosure may be specifically configured to operate in a cloud computing/architecture 525 such as, but not limiting to: infrastructure a service (IaaS) 710, platform as a service (PaaS) 708, and/or software as a service (SaaS) 706 using a web browser, mobile app, thin client, terminal emulator or other endpoint 704. FIGS. 6 and 7 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk(TM), TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 20 cm or less. In some embodiments, the NFC may operate at 23.56 MHz on ISO/IEC 28000-3 air interface and at rates ranging from 206 kbit/s to 424 kbit/s. In some embodiments, the NFC can involve an initiator and a target; the initiator actively generates an RF field that can power a passive target. In some embodiments, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various users or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) Linux, (2) Microsoft Windows, (3) OS X (Mac OS), (4) Solaris, (5) UNIX (6) VMWare, (7) Android, (8) Java Platforms, (9) Open Web Platform, (10) Kubernetes or other suitable computer platforms. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 200 (e.g., but not limited to, 200-999), at least 2,000 (e.g., but not limited to, 2,000-9,999), at least 20,000 (e.g., but not limited to, 20,000-99,999), at least 200,000 (e.g., but not limited to, 200,000-999,999), at least 2,000,000 (e.g., but not limited to, 2,000,000-9,999,999), at least 20,000,000 (e.g., but not limited to, 20,000,000-99,999,999), at least 200,000,000 (e.g., but not limited to, 200,000,000-999,999,999), at least 2,000,000,000 (e.g., but not limited to, 2,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

As used herein, the term “mobile device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH),WHIRLPOOL, RNGs).

The aforementioned examples are, of course, illustrative and not restrictive.

As used herein, the term “user” shall have a meaning of at least one user. In some embodiments, the terms “user”, “subscriber” “consumer” or “user” should be understood to refer to a user of an application or applications as described herein, and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

At least some aspects of the present disclosure will now be described with reference to the following numbered clauses.

Clause 1. A method comprising:

receiving, by at least one processor, an activity verification request from an initiator device associated with an entity in response to a user interaction of a user with the initiator device;
wherein the activity verification request comprises a plurality of data fields associated with a messaging standard;
wherein the plurality of data fields comprise at least one auxiliary data field;
wherein the at least one auxiliary data field comprises an identifier of a workflow associated with the entity;

determining, by the at least one processor, a secure workflow based at least in part on:
i) the identifier of the workflow, and
ii) at least one registered workflow;

generating, by the at least one processor, a device-specific workflow token for a workflow service to execute a device-specific instance of the secure workflow;
wherein the device-specific workflow token is associated with the initiator device;

transmitting, by the at least one processor, the device-specific workflow token to the initiator device;

receiving, by the at least one processor from the initiator device, a workflow request comprising workflow data and the device-specific workflow token;
wherein the workflow data comprises:
   i) at least one trigger condition, and
   ii) an indication of the at least one trigger condition having been satisfied;

executing, by the at least one processor, within the workflow service, the device-specific instance of the secure workflow based at least in part on:
i) the workflow request, and
ii) user data of the user;
wherein the user data of the user confidentially stored separate from the entity;

generating, by the at least one processor, at least one status notification in response to the executing of the device-specific instance of the secure workflow;
wherein the at least one status notification comprises the indication of the at least one trigger condition having been satisfied; and

transmitting, by the at least one processor, the at least one status notification to the initiator device, a computing device associated with the user, or both.

Clause 2. A system comprising:

at least one processor configured to execute software instruction causing the at least one processor to perform steps to:
receive an activity verification request from an initiator device associated with an entity in response to a user interaction of a user with the initiator device;
   wherein the activity verification request comprises a plurality of data fields associated with a messaging standard;
   wherein the plurality of data fields comprise at least one auxiliary data field;
   wherein the at least one auxiliary data field comprises an identifier of a workflow request associated with the entity;
determine a secure workflow based at least in part on:
   i) the identifier of the workflow request, and
   ii) at least one registered workflow;
generate a device-specific workflow token for a workflow service to execute a device-specific instance of the secure workflow;
   wherein the device-specific workflow token is associated with the initiator device;
transmit the device-specific workflow token to the initiator device;
receive, from the initiator device, a workflow request comprising workflow data and the device-specific workflow token;
   wherein the workflow data comprises:
      i) at least one trigger condition, and
      ii) an indication of the at least one trigger condition having been satisfied;
execute within the workflow service, the device-specific instance of the secure workflow based at least in part on:
   i) the workflow request, and
   ii) user data of the user;
   wherein the user data of the user confidentially stored separate from the entity;
generate at least one status notification in response to the executing of the device-specific instance of the secure workflow;
   wherein the at least one status notification comprises the indication of the at least one trigger condition having been satisfied; and
transmit the at least one status notification to the initiator device, a computing device associated with the user, or both.
   Clause 3. A method comprising:

receiving, by at least one processor, an authorization request from an initiator device associated with an entity in response to a user interaction of a user with the initiator device;
wherein the authorization request comprises a plurality of data fields associated with a messaging standard;
wherein the plurality of data fields comprise at least one auxiliary data field;
wherein the at least one auxiliary data field comprises an identifier of a workflow associated with the entity;

determining, by the at least one processor, a secure workflow based at least in part on:
i) the identifier of the workflow, and
ii) at least one registered workflow;

executing, by the at least one processor, within a workflow service, an instance of the secure workflow to produce at least one device-specific activity-related notification based at least in part on:
i) the authorization request, and
ii) user data of the user;
wherein the user data of the user confidentially stored separate from the entity; and

transmitting, by the at least one processor, the at least one device-specific activity-related notification a computing device associated with the user.

Clause 4. The systems and methods of any of clauses 1 through 3, further comprising electronically communicating, by the at least one processor, the at least one status notification to contact information identified in the user data, wherein the contact information identifies a communication address of the computing device.
Clause 5. The systems and methods of clause 2, wherein the contact information comprises a telephone number specified in a user account at a financial institution and the at least one status notification comprises a text message to the telephone number.
Clause 6. The systems and methods of any of clauses 1 through 3, wherein the device-specific workflow token is a one-time token that expires upon generating the at least one status notification.
Clause 7. The systems and methods of any of clauses 1 through 3, wherein the messaging standard comprises an authorization message standard.
Clause 8. The systems and methods of clause 5, wherein the at least one auxiliary data field comprises at least one data field of the messaging standard that is reserved for private use.
Clause 9. The systems and methods of clause 5, wherein the initiator device comprises a payment system associated with a merchant.
Clause 10. The systems and methods of any of clauses 1 through 3, further comprising receiving, by the at least one processor, the workflow request comprising a transaction fulfillment message from a merchant associated with the initiator device, wherein the transaction fulfillment message indicates a fulfillment of a status of a transaction associated with the activity verification request.
Clause 11. The systems and methods of any of clauses 1 through 3, further comprising:

generating, by the at least one processor, a multi-factor authentication token based on the secure workflow; and

electronically communicating, by the at least one processor, the multi-factor authentication token to the initiator device, the at least one computing device, or both to authenticate the user with the initiator device.

Clause 12. The systems and methods of any of clauses 1 through 3, wherein the at least one status notification comprises a purchased item shipping status.

While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

1. A method comprising:
receiving, by at least one processor, an activity verification request from an initiator device associated with an entity in response to a user interaction of a user with the initiator device;
wherein the activity verification request comprises a plurality of data fields associated with a messaging standard;
wherein the plurality of data fields comprise at least one auxiliary data field;
wherein the at least one auxiliary data field comprises an identifier of a workflow associated with the entity;
determining, by the at least one processor, a secure workflow based at least in part on:
i) the identifier of the workflow, and
ii) at least one registered workflow;
generating, by the at least one processor, a device-specific workflow token for a workflow service to execute a device-specific instance of the secure workflow;
wherein the device-specific workflow token is associated with the initiator device;
transmitting, by the at least one processor, the device-specific workflow token to the initiator device;
receiving, by the at least one processor from the initiator device, a workflow request comprising workflow data and the device-specific workflow token;
wherein the workflow data comprises:
i) at least one trigger condition, and
ii) an indication of the at least one trigger condition having been satisfied;
executing, by the at least one processor, within the workflow service, the device-specific instance of the secure workflow based at least in part on:
i) the workflow request, and
ii) user data of the user;
wherein the user data of the user is confidentially stored separate from the entity;
generating, by the at least one processor, at least one status notification in response to the executing of the device-specific instance of the secure workflow;
wherein the at least one status notification comprises the indication of the at least one trigger condition having been satisfied; and
transmitting, by the at least one processor, the at least one status notification to the initiator device, a computing device associated with the user, or both.

2. The method of claim 1, further comprising electronically communicating, by the at least one processor, the at least one status notification to contact information identified in the user data, wherein the contact information identifies a communication address of the computing device.

3. The method of claim 2, wherein the contact information comprises a telephone number specified in a user account at a financial institution and the at least one status notification comprises a text message to the telephone number.

4. The method of claim 1, wherein the device-specific workflow token is a one-time token that expires upon generating the at least one status notification.

5. The method of claim 1, wherein the messaging standard comprises an authorization message standard.

6. The method of claim 5, wherein the at least one auxiliary data field comprises at least one data field of the messaging standard that is reserved for private use.

7. The method of claim 5, wherein the initiator device comprises a payment system associated with a merchant.

8. The method of claim 1, further comprising receiving, by the at least one processor, the workflow request comprising a transaction fulfillment message from a merchant associated with the initiator device, wherein the transaction fulfillment message indicates a fulfillment of a status of a transaction associated with the activity verification request.

9. The method of claim 1, further comprising:
generating, by the at least one processor, a multi-factor authentication token based on the secure workflow; and
electronically communicating, by the at least one processor, the multi-factor authentication token to the initiator device, the at least one computing device, or both to authenticate the user with the initiator device.

10. The method of claim 1, wherein the at least one status notification comprises a purchased item shipping status.

11. A system comprising:
at least one processor configured to execute software instruction causing the at least one processor to perform steps to:
receive an activity verification request from an initiator device associated with an entity in response to a user interaction of a user with the initiator device;
wherein the activity verification request comprises a plurality of data fields associated with a messaging standard;
wherein the plurality of data fields comprise at least one auxiliary data field;
wherein the at least one auxiliary data field comprises an identifier of a workflow request associated with the entity;
determine a secure workflow based at least in part on:
i) the identifier of the workflow request, and
ii) at least one registered workflow;
generate a device-specific workflow token for a workflow service to execute a device-specific instance of the secure workflow;
wherein the device-specific workflow token is associated with the initiator device;
transmit the device-specific workflow token to the initiator device;
receive, from the initiator device, a workflow request comprising workflow data and the device-specific workflow token;
wherein the workflow data comprises:
i) at least one trigger condition, and
ii) an indication of the at least one trigger condition having been satisfied;
execute within the workflow service, the device-specific instance of the secure workflow based at least in part on:
i) the workflow request, and
ii) user data of the user;
wherein the user data of the user is confidentially stored separate from the entity;
generate at least one status notification in response to the executing of the device-specific instance of the secure workflow;
wherein the at least one status notification comprises the indication of the at least one trigger condition having been satisfied; and
transmit the at least one status notification to the initiator device, a computing device associated with the user, or both.

12. The system of claim 11, wherein the software instruction further cause the at least one processor to perform steps to electronically communicate the at least one status notification to contact information identified in the user data, wherein the contact information identifies a communication address of the computing device.

13. The system of claim 12, wherein the contact information comprises a telephone number specified in a user account at a financial institution and the at least one status notification comprises a text message to the telephone number.

14. The system of claim 11, wherein the device-specific workflow token is a one-time token that expires upon generating the at least one status notification.

15. The system of claim 11, wherein the messaging standard comprises an authorization message standard.

16. The system of claim 15, wherein the at least one auxiliary data field comprises at least one data field of the messaging standard that is reserved for private use.

17. The system of claim 15, wherein the initiator device comprises a payment system associated with a merchant.

18. The system of claim 11, wherein the software instruction further cause the at least one processor to perform steps to receive the workflow request comprising a transaction fulfillment message from a merchant associated with the initiator device, wherein the transaction fulfillment message indicates a fulfillment of a status of a transaction associated with the activity verification request.

19. The system of claim 11, wherein the software instruction further cause the at least one processor to perform steps to:
generate a multi-factor authentication token based on the secure workflow; and
electronically communicate the multi-factor authentication token to the initiator device, the computing device, or both to authenticate the user with the initiator device.

20. A method comprising:
receiving, by at least one processor, an authorization request from an initiator device associated with an entity in response to a user interaction of a user with the initiator device;
wherein the authorization request comprises a plurality of data fields associated with a messaging standard;
wherein the plurality of data fields comprise at least one auxiliary data field;
wherein the at least one auxiliary data field comprises an identifier of a workflow associated with the entity;
determining, by the at least one processor, a secure workflow based at least in part on:
i) the identifier of the workflow, and
ii) at least one registered workflow;
executing, by the at least one processor, within a workflow service, an instance of the secure workflow to produce at least one device-specific activity-related notification based at least in part on:
i) the authorization request, and
ii) user data of the user;
wherein the user data of the user is confidentially stored separate from the entity; and
transmitting, by the at least one processor, the at least one device-specific activity-related notification a computing device associated with the user.
